(19) United States
(12) Patent Application Publication
(10) Pub. No.: US 2026/0235751 A1
(43) Pub. Date: Aug. 13, 2026

(54) APPARATUS AND METHOD FOR RECOGNIZING OF ROAD EDGE BASED ON SENSING DATA

(71) Applicant: HL KLEMOVE CORPORATION, Incheon (KR)

(72) Inventor: JongGu KANG, Incheon (KR)

(73) Assignee: HL KLEMOVE CORPORATION, Incheon (KR)

(21) Appl. No.: 19/311,241

(22) Filed: Aug. 27, 2025

(30) Foreign Application Priority Data
Feb. 13, 2025 (KR) 10-2025-0018659

(51) Int. Cl. G01S 13/931; B60W 10/20; B60W 30/09; B60W 30/14; G01S 13/89

(52) U.S. Cl. CPC G01S 13/931; B60W 30/09; B60W 30/143; G01S 13/89; B60W 10/20; B60W 2552/50; B60W 2554/20; B60W 2556/40; B60W 2710/207; B60W 2720/10

(57) ABSTRACT

The present disclosure relates to an apparatus and a method for recognizing a road edge based on sensing data. The apparatus for recognizing a road edge includes a memory in which at least one instruction is stored, and a processor configured to execute the at least one instruction. The processor receives sensing data, generates a grid map including information on the probability of the presence of an object and coordinates based on the sensing data, and determines at least one cluster by applying a sliding window method to the grid map and extracts a feature of the cluster.

### CROSS-REFERENCE TO RELATED APPLICATION

This application claims priority to and the benefit of Korean Patent Application No. 10-2025-0018659, filed on Feb. 13, 2025, the disclosure of which is incorporated herein by reference in its entirety.

### BACKGROUND

### Technical Field

The present disclosure relates to an apparatus and a method for recognizing a road edge based on sensing data.

### Description of Related Art

Recently, with increasing demands not only for vehicle performance but also for driver convenience and safety, research and development of driver assist systems (DAS) and autonomous driving have been actively conducted. These systems assist in vehicle control based on sensing data acquired through sensors mounted on the vehicle.

In particular, autonomous driving systems mounted on vehicles generally measure the lane width, the lateral position of the vehicle relative to the lane, the distances to the lane boundaries on both sides, the lane shape, and the curvature radius of the road based on image processing of camera data. Then, based on the vehicle position and road information obtained therefrom, the systems control steering, gear shifting, acceleration, braking of the vehicle, and the like.

In addition, autonomous driving systems use a radar sensor, which is a distance sensing means mounted at a predetermined position in front of the vehicle, to detect road edges—including a preceding vehicle traveling ahead, structures installed around the road, and vehicles approaching from the opposite lane. The system calculates the distance to the preceding vehicle traveling in the same direction or to a stationary object, and provides an advanced smart cruise control function that automatically performs deceleration and acceleration according to the situation.

When providing such an advanced smart cruise control function, structures such as guardrails among the detected objects may be mistakenly recognized as preceding vehicles rather than stationary objects due to their characteristic repetitive shapes.

To more accurately recognize road edges such as guardrails, laser scanners have recently been mounted on vehicles. However, since laser scanners are expensive devices, they cause an increase in production cost, which may weaken price competitiveness.

### BRIEF SUMMARY

Embodiments of the present disclosure, devised to address the above-described conventional problems, are directed to providing an apparatus and a method for recognizing a road edge based on sensing data, by generating a grid map of a road during driving based on sensing data acquired from a radar sensor mounted on a vehicle and identifying the road edge using sensing data capable of indicating the road edge on the grid map.

In addition, embodiments of the present disclosure is directed to providing an apparatus and a method for recognizing a road edge based on sensing data, by clustering at least one object identified from sensing data acquired by a radar sensor mounted on a vehicle and recognizing the road edge and estimating the curvature of the road edge using sensing data based on a sliding window method.

An apparatus for recognizing a road edge according to an embodiment of the present disclosure for solving the above problems may include a memory in which at least one instruction is stored; and a processor configured to execute the at least one instruction, wherein the processor may be configured to receive sensing data; generate a grid map including information on the probability of the presence of an object and coordinates based on the sensing data; and determine at least one cluster by applying a sliding window method to the grid map, and extract a feature of the cluster, wherein the feature may be a set of coordinates of the cluster.

In an embodiment of the present disclosure, the processor may be further configured to estimate a curvature of the cluster.

In an embodiment of the present disclosure, the feature of the cluster may be determined as the coordinates of a grid having the highest probability of object presence among the grids included in the window.

In an embodiment of the present disclosure, the processor may be configured to calculate a probability of object presence for each grid using the sensing data and an inverse sensor model.

In an embodiment of the present disclosure, the processor may be configured to calculate an accumulated probability over time for the grid; and determine a grid whose accumulated probability is equal to or greater than a preset probability as an occupied grid.

In an embodiment of the present disclosure, the processor may be configured to perform clustering only on the occupied grids among the grids.

In an embodiment of the present disclosure, the processor may be configured to perform clustering on static objects among the objects based on the sensing data.

In an embodiment of the present disclosure, the processor may be configured to approximate a curve formed by the cluster using a third-degree polynomial and then estimate the curvature.

In an embodiment of the present disclosure, the processor may be configured to control the vehicle using at least one of the feature or the curvature of the cluster.

In an embodiment of the present disclosure, the processor may be configured to perform control for at least one of collision avoidance, speed control, steering angle adjustment, or stopping of the vehicle using at least one of the feature or the curvature of the cluster.

A method for recognizing a road edge according to an embodiment of the present disclosure for solving the above problems may include receiving sensing data; generating a grid map including information on the probability of the presence of an object and coordinates based on the sensing data; and determining at least one cluster by applying a sliding window method to the grid map, and extracting a feature of the cluster, wherein the feature may be a set of coordinates of the cluster.

In an embodiment of the present disclosure, the method may further include estimating a curvature of the cluster.

In an embodiment of the present disclosure, the feature of the cluster may be determined as the coordinates of a grid having the highest probability of object presence among the grids included in the window.

In an embodiment of the present disclosure, the method may further include calculating a probability of object presence for each grid using the sensing data and an inverse sensor model.

In an embodiment of the present disclosure, the method may further include calculating an accumulated probability over time for the grid; and determining a grid whose accumulated probability is equal to or greater than a preset probability as an occupied grid.

In an embodiment of the present disclosure, clustering may be performed only on the occupied grids among the grids.

In an embodiment of the present disclosure, clustering is performed on static objects among the objects based on the sensing data.

In an embodiment of the present disclosure, the method may further include approximating a curve formed by the cluster using a third-degree polynomial and then estimating the curvature.

In an embodiment of the present disclosure, the method may further include controlling a vehicle using at least one of the feature or the curvature of the cluster.

In an embodiment of the present disclosure, the controlling a vehicle may include performing control for at least one of collision avoidance, speed control, steering angle adjustment, or stopping of the vehicle using at least one of the feature or the curvature of the cluster.

As described above, the apparatus and method for recognizing a road edge based on sensing data according to the present disclosure can more accurately identify a road edge within the detection range of a radar sensor by generating a grid map of a road during driving based on sensing data acquired from a radar sensor mounted on a vehicle and indicating the road edge on the grid map.

In addition, the apparatus and method for recognizing a road edge based on sensing data according to the present disclosure can cluster at least one object identified from sensing data acquired by a radar sensor mounted on a vehicle and recognize the road edge and estimate its curvature using a sliding window method, thereby enabling more accurate and safer advanced smart cruise control functionality while minimizing cost increase.

### BRIEF DESCRIPTION OF THE DRAWINGS

FIG. 1 is a diagram illustrating the main components of an apparatus for recognizing a road edge according to an embodiment of the present disclosure.

FIG. 2 is a flowchart for explaining a method for recognizing a road edge according to an embodiment of the present disclosure.

FIG. 3 illustrates an actual road image alongside a visualization of a first grid map.

FIG. 4 illustrates a visualization of a second grid map.

FIG. 5 is provided to explain clustering by a sliding window method.

FIG. 6 shows the results of clustering along with the corresponding real-world objects.

FIG. 7 shows the results of clustering along with the corresponding real-world objects.

### DETAILED DESCRIPTION

Hereinafter, specific embodiments according to an embodiment of the present disclosure will be described with reference to the drawings. The following detailed description is provided to aid in a comprehensive understanding of the methods, apparatuses, and/or systems described in the present specification. However, this is merely exemplary, and the present disclosure is not limited thereto.

In describing the embodiments of the present disclosure, detailed descriptions of related known technologies will be omitted when it is determined that such descriptions may unnecessarily obscure the gist of the embodiments. The terms used below are defined in consideration of the functions within the present disclosure and may vary depending on user, operator intention, or customary usage or the like. Therefore, the definitions should be interpreted based on the overall content of this specification. The terminology used in the detailed description is intended merely to describe exemplary embodiments and should not be construed as limiting. Unless explicitly stated otherwise, expressions in the singular form include the plural meaning as well. In the present description, expressions such as “comprise,” “include,” or “provide” are intended to indicate the presence of stated features, numbers, steps, operations, elements, components, or combinations thereof, and should not be interpreted as excluding the possibility of the presence or addition of one or more other features, numbers, steps, operations, elements, components, or combinations thereof. In addition, terms such as “unit,” “device,” “means,” “part,” “member,” “module,” “block.” etc., which are described in the specification, mean a unit of a comprehensive configuration that performs at least one function or operation, which may be implemented in hardware or software, or in a combination of hardware and software.

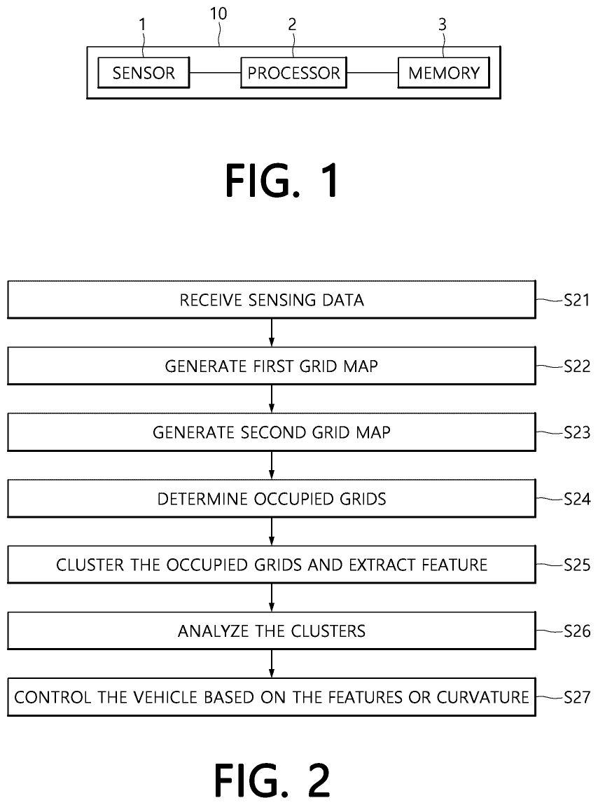

FIG. 1 is a diagram illustrating the main components of an apparatus for recognizing a road edge according to an embodiment of the present disclosure.

Referring to FIG. 1, an apparatus 10 according to the present disclosure may be a computing apparatus, such as an electronic apparatus, that provides an advanced smart cruise control function or an autonomous driving function of a vehicle. The apparatus 10 may include a sensor 1, a processor 2, and a memory 3.

The sensor 1 may be a radar (RADAR; radio detecting and ranging) sensor that emits radio waves over a certain area and collects sensing data such as the position and speed of an object located in front of the vehicle by measuring the time it takes for the emitted radio waves to be reflected and return.

The processor 2 collects sensing data acquired by the sensor 1, such as a radar sensor, provided in the front of the vehicle during driving.

The processor 2 may set a reference coordinate system corresponding to the size of the radar detection area detected by the radar sensor. The reference coordinate system may be pre-stored in the memory 3.

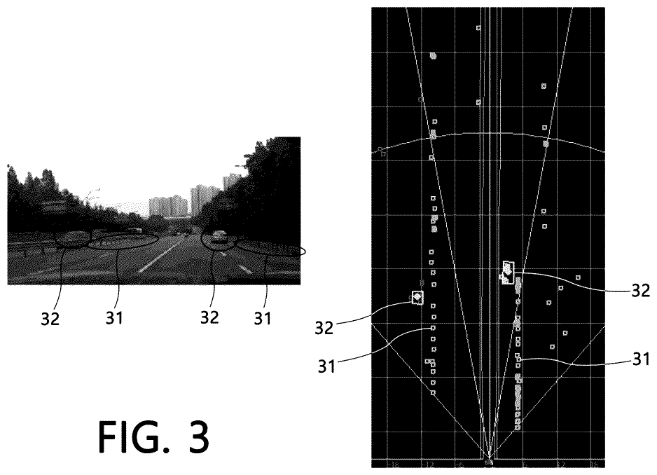

The processor 2 may convert the object detected by the radar sensor into coordinates of the reference coordinate system and generate first grid map information including the coordinates of the object. Here, a grid 31 corresponds to a resolution identifiable by the radar sensor and may be associated with information on the presence of an object or the probability of the presence of an object in the corresponding space. For example, the grid may be a projection onto the reference coordinate system of an area corresponding to a resolution of 0.5 m×0.5 m in the real space. FIG. 3 is a visualization of the first grid map, in which a plurality of grids 31 projected onto the reference coordinate system is shown.

Meanwhile, objects identified by the grids may include static objects 31 and dynamic objects 32. A static object 31 refers to an object having a relative speed of zero with respect to the ground surface, while a dynamic object 32 refers to an object having a nonzero relative speed with respect to the ground surface. Among these, the objects subject to road edge analysis are the static objects 31.

The processor 2 may apply an inverse sensor model to each grid 31 to calculate the probability that the corresponding grid 31 is occupied by an object.

The processor 2 may generate information obtained by projecting, onto the reference coordinate system, the grid 31 and the probability of occupancy of the object corresponding to the coordinates of the grid 31. This information is referred to as second grid map information.

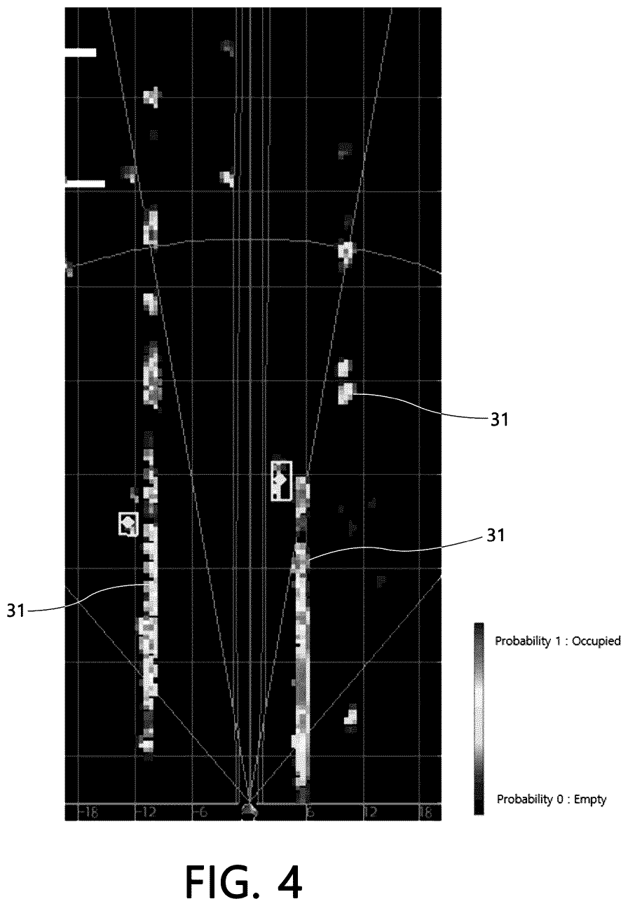

FIG. 4 is a visualization of the second grid map, in which a plurality of grids projected onto the reference coordinate system is shown along with the probability of object occupancy for each grid.

The probability of object occupancy may have a value between 0 and 1. A value of 0 indicates the highest probability that the corresponding space is empty, while a value of 1 indicates the highest probability that the space is occupied by an object.

The processor 2 may identify, among the objects detected from the sensing data, those having a probability value, and may convert the positions of the identified objects into the coordinate system of the reference coordinate map to display them on the reference coordinate map. At this time, the processor 2 may calculate probability values only for static objects.

The processor 2 may calculate an accumulated probability for each grid 31 over a preset time range. The calculation of the accumulated probability may reduce the possibility of error in the probability of the presence of a static object.

The processor 2 may determine a grid 31 whose accumulated probability is equal to or greater than a preset probability as an occupied grid 31. This may involve the processor 2 storing identification information of the grid 31 with an accumulated probability equal to or greater than the preset probability in the memory 3. For example, the identification information may be the coordinates of the corresponding grid 31 in the reference coordinate system.

The processor 2 may perform clustering and feature extraction on the determined plurality of occupied grids 31.

The clustering and feature extraction for the plurality of occupied grids 31 may be performed based on a sliding window method.

The sliding window method is a method in which a window 51 of a preset size or a size adaptively adjusted is slid by changing its coordinates over the reference coordinate system, and features within the window 51 are extracted. The size of the window 51 may be pre-stored in the memory 3 or adaptively set by the processor 2.

In the present disclosure, the feature within the window 51 may be the coordinates of the occupied grid 31 having the highest object occupancy probability among the occupied grids 31 within the window 51.

The processor 2 may apply the sliding window method to perform clustering and feature extraction simultaneously.

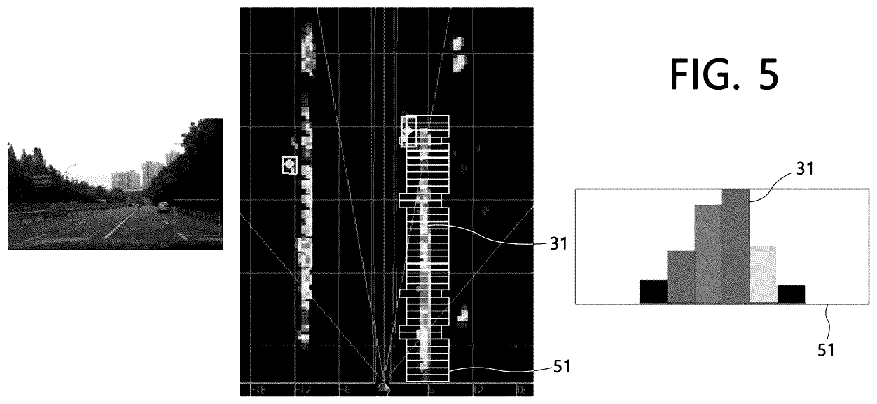

For example, referring to FIG. 5, the window 51 may be slid from the bottom left of the reference coordinate system toward the right while searching for occupied grids 31. After finding the first local maximum, the processor 2 may move the window 51 to surrounding coordinates such as the right or upper side centered on the local maximum to search for other local maxima. The processor 2 may store, in the memory 3, information indicating that adjacent local maxima are included in the same cluster. In this case, adjacency may be required to fall within a preset range based on the distance or angle between local maxima. However, the criteria for determining adjacency may be set differently as needed.

In FIG. 5, the left side shows objects being clustered by the sliding window on an actual road, the center shows occupied grids 31 being clustered into a single cluster using a plurality of windows 51, and the right side illustrates a probability distribution among the plurality of occupied grids 31 within the sliding window 51. According to the probability distribution on the right, the coordinates of the occupied grid 31 corresponding to the fourth probability from the left may be stored as feature information of the cluster to which the grid 31 belongs.

The processor 2 may store, for each window 51, the coordinates with the highest probability value through the sliding window method. The coordinates belonging to the same cluster may be one of the types of feature information representing a road edge.

The road edge may be any one of a curb, flexible post, guardrail, soundproof wall, road junction, railing, bush, or tunnel, and may also be an object other than the examples listed.

The processor 2 may determine at least one cluster or different clusters from the second grid map information and store information about the cluster(s) in the memory 3.

The processor 2 may perform analysis on at least one cluster.

The analysis of the cluster may include generating information related to the curvature of the cluster.

The information related to curvature may be obtained by approximating the coordinates belonging to a cluster using a polynomial and estimating the curvature of the cluster based on the approximated polynomial.

For example, the processor 2 may approximate the coordinates belonging to the cluster using a third-degree polynomial. The processor 2 may estimate the curvature of a portion of the curve represented by the approximated third-degree polynomial using the approximated third-degree polynomial.

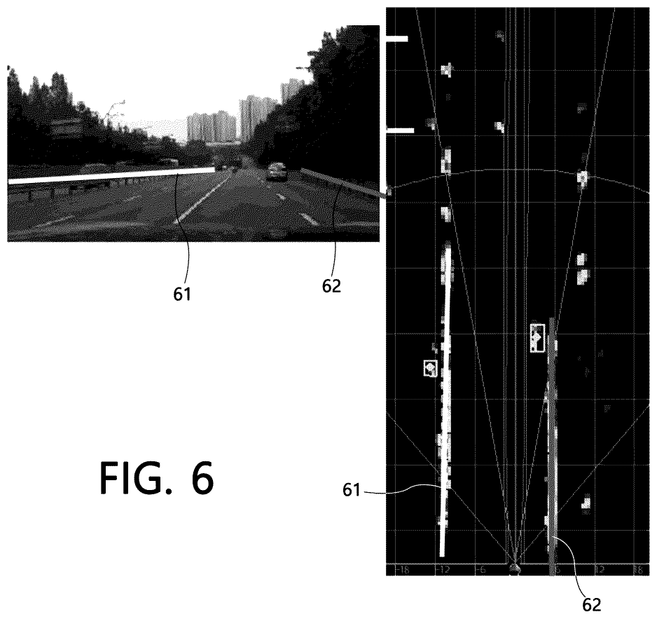

FIG. 6 shows the results of clustering along with the corresponding real-world objects.

On the left side of FIG. 6, a guardrail corresponding to a first cluster 61 and a plurality of bollards corresponding to a second cluster 62 are shown in the photograph.

On the right side of FIG. 6, the first cluster 61 and the second cluster 62 are respectively displayed in the second grid map.

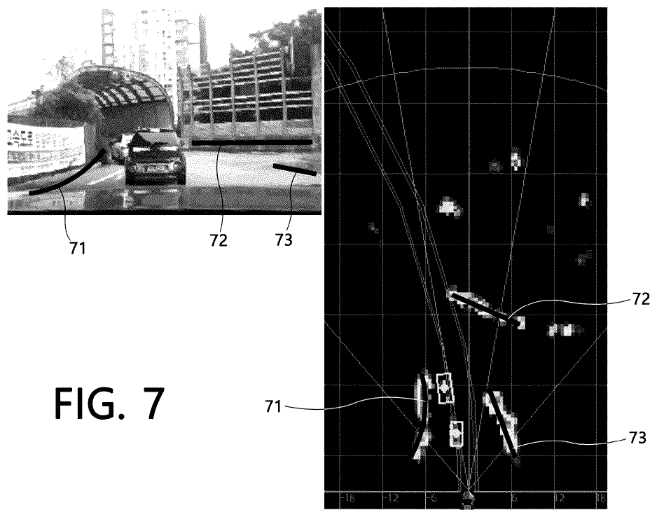

FIG. 7 shows the results of clustering along with the corresponding real-world objects.

On the left side of FIG. 7, objects respectively corresponding to a first cluster 71, a second cluster 72, and a third cluster 73 are shown.

On the right side of FIG. 7, the first cluster 71, the second cluster 72, and the third cluster 73 are respectively displayed in the second grid map.

FIG. 7 demonstrates that information on various road edges can be recognized as clustered information.

The processor 2 may control the vehicle using at least one of the cluster information, feature information of the cluster, or curvature information of the cluster. To this end, the processor 2 may be installed in the vehicle and connected to a controller that mechanically controls the vehicle, thereby transmitting and receiving information.

The processor 2 may perform control for at least one of collision avoidance, speed control, steering angle adjustment, or stopping of the vehicle using at least one of the cluster information, feature information of the cluster, or curvature information of the cluster.

The memory 3 may store a program for controlling the apparatus 10. In particular, the memory 3 may store a reference coordinate system for the area in which radio waves are emitted from the radar sensor, the size of the grid, an algorithm for generating a grid map, an inverse sensor model of the radar sensor, a clustering algorithm, an algorithm related to the sliding window method, an algorithm for approximating a third-degree polynomial, a curvature estimation algorithm, and the like.

FIG. 2 is a flowchart for explaining a method for recognizing a road edge according to an embodiment of the present disclosure. The method for recognizing a road edge corresponds to the operation of the processor 2 described above, and only the essential aspects will be explained herein, with redundant details being omitted as they have been described above.

Referring to FIG. 2, the processor 2 receives sensing data acquired by a sensor 1, such as a radar sensor, mounted on a front portion of the vehicle during driving (S21). The reception of the sensing data may be continuously performed at predetermined time intervals.

The processor 2 may convert the object detected by the radar sensor into coordinates of the reference coordinate system and generate first grid map information including the coordinates of the object (S22).

The processor 2 may generate second grid map information, which is information obtained by projecting, onto the reference coordinate system, the grid 31 and the probability of occupancy of the object corresponding to the coordinates of the grid 31 (S23). This may be the result of the processor 2 applying an inverse sensor model to each grid 31 to calculate the probability that the corresponding grid 31 is occupied by an object.

The processor 2 may determine at least some of the grids 31 as occupied grids 31 (S24). This determination may include the processor 2 calculating an accumulated probability for each grid 31 over a preset time range, and determining a grid 31 whose accumulated probability is equal to or greater than a preset probability as an occupied grid 31.

The processor 2 may perform clustering and feature extraction on the determined plurality of occupied grids 31 (S25).

The processor 2 may determine at least one cluster or different clusters from the second grid map information and store information about the cluster(s) in the memory 3.

The processor 2 may perform analysis on at least one cluster (S26). The analysis of the cluster may include generating information related to the curvature of the cluster.

The processor 2 may control the vehicle using at least one of the cluster information, feature information of the cluster, or curvature information of the cluster (S27).

The processor 2 may perform control for at least one of collision avoidance, speed control, steering angle adjustment, or stopping of the vehicle using at least one of the cluster information, feature information of the cluster, or curvature information of the cluster.

Hereinafter, polynomial approximation and curvature estimation for a cluster will be described as an example, which represents one possible example among various approximation and estimation methods.

The processor 2 may approximate the coordinate values of a given cluster using a third-degree polynomial as shown in [Mathematical Equation 1] below.

$$\hat{y} = {a}_{0} + {a}_{1} x + {a}_{2} {x}^{2} + {a}_{3} {x}^{3} \qquad [ Mathematical Equation 1 ]$$

In this case, the coefficients of the first-degree, second-degree, and third-degree terms may affect the result of the curvature calculation.

Specifically, the processor 2 may use a linear regression method based on the least squares method, and may approximate the coordinates of the cluster using a third-degree polynomial by minimizing the sum of squared errors (SSE) as expressed in [Mathematical Equation 2] below.

$$SSE ( {a}_{0} , {a}_{1} , {a}_{2} , {a}_{3} ) = {\sum }_{i = 1}^{n} {( {y}_{1} - ( {a}_{0} + {a}_{1} {x}_{i} + {a}_{2} {x}_{i}^{2} + {a}_{3} {x}_{i}^{3} ) )}^{2} \qquad [ Mathematical Equation 2 ]$$

In this case, xᵢ,yᵢ represent the ith coordinate included in the cluster.

The processor 2 may calculate curvature information of the cluster using the approximated third-degree polynomial.

While the present disclosure has been described in detail with reference to representative embodiments, it will be understood by those skilled in the art that various modifications and equivalent other embodiments may be possible based on the present disclosure. Accordingly, the true technical scope of the present disclosure should be defined by the spirit of the appended claims.

1. An apparatus for recognizing a road edge, comprising:
a memory in which at least one instruction is stored; and
a processor configured to execute the at least one instruction;
wherein the processor is configured to:
receive sensing data;
generate a grid map including information on the probability of the presence of an object and coordinates based on the sensing data; and
determine at least one cluster by applying a sliding window method to the grid map, and extract a feature of the cluster, the feature being a set of coordinates of the cluster.

2. The apparatus of claim 1, wherein the processor is further configured to estimate a curvature of the cluster.

3. The apparatus of claim 1, wherein the feature of the cluster is determined as the coordinates of a grid having the highest probability of object presence among the grids included in the window.

4. The apparatus of claim 1, wherein the processor is configured to calculate a probability of object presence for each grid using the sensing data and an inverse sensor model.

5. The apparatus of claim 1, wherein the processor is configured to:
calculate an accumulated probability over time for the grid; and
determine a grid whose accumulated probability is equal to or greater than a preset probability as an occupied grid.

6. The apparatus of claim 5, wherein the processor is configured to perform clustering only on the occupied grids among the grids.

7. The apparatus of claim 1, wherein the processor is configured to perform clustering on static objects among the objects based on the sensing data.

8. The apparatus of claim 2, wherein the processor is configured to approximate a curve formed by the cluster using a third-degree polynomial and then estimate the curvature.

9. The apparatus of claim 2, wherein the processor is configured to control the vehicle using at least one of the feature or the curvature of the cluster.

10. The apparatus of claim 9, wherein the processor is configured to perform control for at least one of collision avoidance, speed control, steering angle adjustment, or stopping of the vehicle using at least one of the feature or the curvature of the cluster.

11. A method for recognizing a road edge, performed by a processor executing at least one instruction stored in a memory, the method comprising:
receiving sensing data;
generating a grid map including information on the probability of the presence of an object and coordinates based on the sensing data; and
determining at least one cluster by applying a sliding window method to the grid map, and extracting a feature of the cluster, the feature being a set of coordinates of the cluster.

12. The method of claim 11, further comprising:
estimating a curvature of the cluster.

13. The method of claim 11, wherein the feature of the cluster is determined as the coordinates of a grid having the highest probability of object presence among the grids included in the window.

14. The method of claim 11, further comprising:
calculating a probability of object presence for each grid using the sensing data and an inverse sensor model.

15. The method of claim 11, further comprising:
calculating an accumulated probability over time for the grid; and
determining a grid whose accumulated probability is equal to or greater than a preset probability as an occupied grid.

16. The method of claim 15, wherein clustering is performed only on the occupied grids among the grids.

17. The method of claim 11, wherein clustering is performed on static objects among the objects based on the sensing data.

18. The method of claim 12, further comprising:
approximating a curve formed by the cluster using a third-degree polynomial and then estimating the curvature.

19. The method of claim 12, further comprising:
controlling a vehicle using at least one of the features or the curvature of the cluster.

20. The method of claim 19, wherein the controlling a vehicle includes performing control for at least one of collision avoidance, speed control, steering angle adjustment, or stopping of the vehicle using at least one of the feature or the curvature of the cluster.
